(19) United States
(12) Patent Application Publication
(10) Pub. No.: US 2009/0027301 A1
(43) Pub. Date: Jan. 29, 2009

(54) DUAL-SCREEN ELECTRONIC MACHINE WITH CONTENT PARSING FUNCTION AND DISPLAY METHOD FOR DISTRIBUTING DISPLAY DATA ON THE SAME

(76) Inventor: SEAN MOSKO, Taipei (TW)

Correspondence Address: G. LINK CO., LTD., 3550 BELL ROAD, MINOOKA, IL, 60447, US

(21) Appl. No.: 11/828,632

(22) Filed: Jul. 26, 2007

(51) Int. Cl. G09G 5/00; G01C 21/00

(52) U.S. Cl. 345/1.1; 701/213

(57) ABSTRACT

The present invention discloses a dual-screen electronic machine with content parsing function, which comprises: a processor; a main display and a sub display connected with the processor, respectively; a content parsing module, which is to proceed the parsing on the content included in the received data and/or event, and would be based on which application program is the active application program to instruct the active application program to distribute the content to the main display or to the sub display; a memory, which is connected with the processor, and for storing at least one application program, which are executed by the processor, wherein the active application programs would call the content parsing module, and, based on the instructions, displaying these contents on the corresponding main display or sub display.

### FIELD OF THE INVENTION

The present invention relates to an electronic machine with display, and particularly to a dual-screen electronic machine with the function of distributing display data.

### BACKGROUND OF THE INVENTION

U.S. Pat. No. 7,034,799 “BACKLIGHTING DEVICE FOR DUAL LIQUID CRYSTAL DISPLAY AND FOLDER-TYPE MOBILEPHONE THEREWITH” has disclosed a mobile phone with dual liquid crystal displays. U.S. Pat. No. 7,034,799 is related to the structural design of backlight device, which provides the dual liquid crystal displays as backlight source. However, the mobile phone in U.S. Pat. No. 7,034,799 could determine one of the two displays to output the display data by managing the received data or event, so as to enhance the level management on managing the data or event. Thus, the user of the dual-screen mobile phone could more easily handle various situations. But, the content regarding to the art was not disclosed.

### SUMMARY OF THE INVENTION

The first object of the present invention is to provide a dual-screen electronic machine with content parsing function, which could determine and select one from the main display and the sub display to output the display data based on the received data or event.

The second object of the present invention is to provide a display method, which is applied in the dual-screen electronic machine for parsing the content included in the data or event from the received data or event, and determine and select one from the main display and the sub display to output the display data based on the content.

To this end, the present invention provides a dual-screen electronic machine with content parsing function, which comprises: a processor; a main display and a sub display connected with the processor, respectively; a content parsing module, which is to proceed the parsing on the content included in the received data and/or event, and would be based on which application program is the active application program to instruct the active application program to distribute the content to the main display or to the sub display; a memory, which is connected with the processor, and for storing at least one application program, which are executed by the processor, wherein the active application programs would call the content parsing module, and, based on the instructions, displaying these contents on the corresponding main display or sub display.

### BRIEF DESCRIPTION OF THE DRAWINGS

The present invention would be detailed described in the following to make the skilled in the art further understand the objects, features, and effects of the present invention with the embodiments and the attached figures wherein:

FIG. 1 is a circuit architecture diagram for a dual-screen electronic machine with content parsing function according to the present invention;

FIG. 2A is an exemplary screen for the data displayed on the main display by the dual-screen electronic machine with content parsing function according to the present invention;

FIG. 2B is an exemplary screen for the data displayed on the sub display by the dual-screen electronic machine with content parsing function according to the present invention;

FIG. 3 is a call state diagram for the active application programs and the content parsing module according to the present invention; and

FIG. 4 is a flow diagram of the display method according to the present invention.

### DETAILED DESCRIPTION OF THE INVENTION

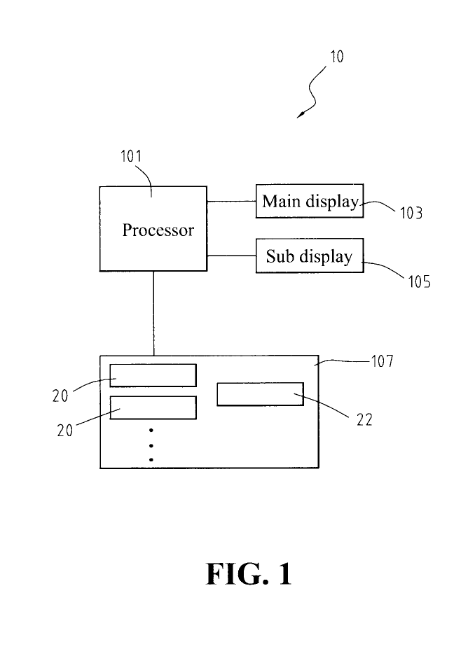

FIG. 1 is a circuit architecture diagram of the dual-screen electronic machine with content parsing function according to the present invention. The dual-screen electronic machine with content parsing function 10 according to the present invention comprises: a processor 101, a main display 103, a sub display 105, a memory 107, at least one application program 20, and a content parsing module 22, which are detailed described in the following.

The processor 101 is used to execute the application programs 20 and the content parsing module 22. When one of the application programs 20 is executing by the processor 101, the application program 20 is the active application program. The active application program 20′ would transmit the real-time received data and event to the content parsing module 22 through the calling means; then, the content parsing module 22 would proceed the parsing based on the content of the received data or event. In the parsing process, the content parsing module 22 would be based on which application program is the active application program 20′ to instruct the contents to be distributed to the main display 103 or to the sub display 105, and returning the instruction result to the active application program 20′; then, the active application program 20′ would follow the instruction result to display the content on the correct display.

With the example for implementing the dual-screen electronic machine 10 according to the present invention as a GPS mobile phone, the data pattern received by the GPS mobile phone 10 would be, for example, the geographic coordinates of a new location (x, y) (New (x, y) coordinates), a location information, a tour guide information, a turning/street information, a new point of interest (POI), an enter text, and the like. The pattern of the event type received by the GPS mobile phone 10 would be, for example, an incoming call, an alert, such as insufficient battery warning, reception of new short message, a search for contact, and the like. After the GPS mobile phone 10 received the above-mentioned data or these events, the active application program 20′ would process the above-mentioned data or events, and the content parsing module 22 would determine which content of the data or the events should be distributed to the main display 103, or to the sub display 105.

The memory 107 is connected with the processor 101, and is used to store the application programs 20 and the content parsing module 22.

Because the dual-screen electronic machine 10 according to the present invention could be implemented as various types of electronic machines, the types of the application programs 20 would be different accordingly. Following the previous example of GPS mobile phone 10, the embodiment of the application programs 20 would, for example, include the navigation application and the phone application.

The processing method on the real-time received data and events by the active application program 20′ would be based on the instruction result from the content parsing module 22, and output the content to the main display 103 or the sub display 105. The navigation application and phone application would be exemplified for description. Please refer to Table 1 and Table 2.

TABLE 1

| Active application program | Received data or event | Display |
|---|---|---|
| Navigation application | New (x, y) coordinates | Main display |
| | Location information | Sub display |
| | Tour guide information | Sub display |
| | Turning/street information | Sub display |
| | New point of interest | Main display |
| | Incoming call | Sub display |
| | Alert | Sub display |

TABLE 2

| Active application program | Received data or event | Display |
|---|---|---|
| Phone application | Search for contact | Sub display |
| | Enter textMain display | Main display |
| | Display name on contact list | Main display |
| | Display detailed information | Sub display |
| | of name on contact list | |
| | Alert | Sub display |

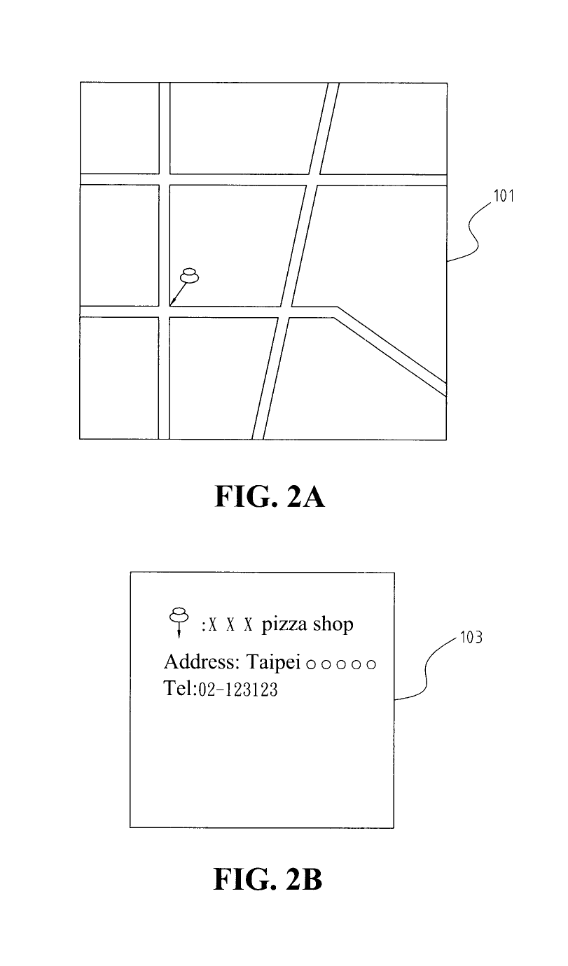

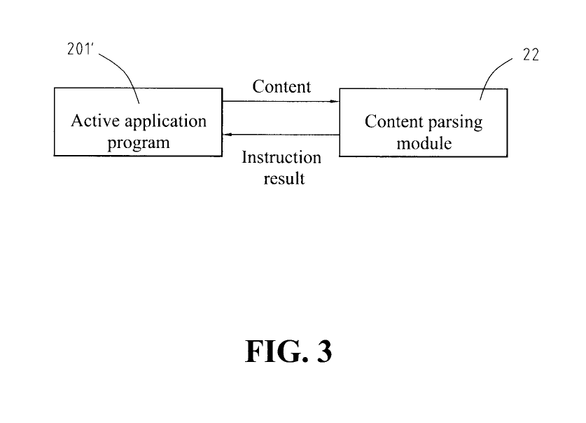

FIG. 2A is an exemplary screen for the data displayed on the main display by the dual-screen electronic machine with content parsing function according to the present invention, and FIG. 2B is an exemplary screen for the data displayed on the sub display by the dual-screen electronic machine with content parsing function according to the present invention, and FIG. 3 is a call state diagram for the active application programs and the content parsing module according to the present invention. As shown in FIGS. 2A, 2B, the active application program 20′ is a navigation application, in which, following the movement of GPS mobile phone 10, the navigation application program 20′ would continuously receive the new (x, y) geographic coordinates; next, the navigation application program 20′ would call the content parsing module 22, and transmit the parameters of new (x, y) coordinates to the content parsing module 22; then, referring to Table 1, the content parsing module 22 would parse the new (x, y) coordinates, and, after parsing, the content parsing module 22 would return the instruction result “distributing to the main display” to the navigation application program 20′; and, the navigation application program 20′ would be based on the instruction result to output and display the newest electronic map to the main display 103, as shown in FIG. 2A.

Following the above example, when the newest electronic map in display involve with the location information, such as some pizza shop, the navigation application program 20′ would process the location information for the pizza shop; next, the navigation application program 20′ would call the content parsing module 22, and transmit the parameters of the location information for the pizza shop to the content parsing module 22; then, referring to Table 1, the content parsing module 22 would parse the location information for the pizza shop, and, after the parsing, the content parsing module 22 would return the instruction result “distributing to the sub display” to the navigation application program 20′; and, the navigation application program 20′ would be based on the instruction result to output and display the information regarding to the pizza shop on the sub display 105, as shown in FIG. 2B.

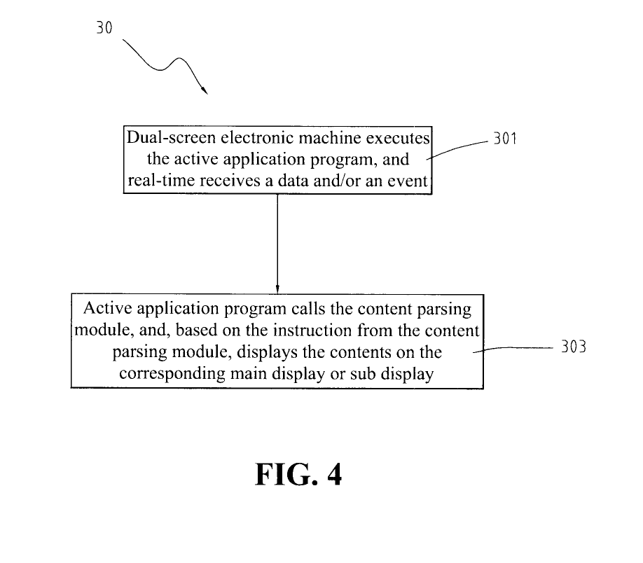

FIG. 4 is a flow chart of the display method according to the present invention. The display method 30 according to the present invention is applied for the dual-screen electronic machine 10. The dual-screen electronic machine at least comprises: a main display 103, a sub display 105, a plurality of application programs 20, a content parsing module 22, and a memory 107. When one of the application programs 20 is executing by the processor 101, the application program 20 is the active application program 20′. The display method 30 includes the step 301, and step 303, which are described as follows.

Step 301 is that the dual-screen electronic machine 10 is executing the active application program 20′, and real-time receives a data and/or an event. Step 303 is that the active application program 20′ calls the content parsing module 22, and, based on the instruction of the content parsing module 22, displays the contents on the corresponding main display 103 or sub display 105.

The content parsing module 22 in Step 303 is used to parse the content included in the received data and/or event, and would be based on which application program is the active application program 20′ to instruct the active application program 20′ to distribute the contents to the main display 103 or to the sub display 105.

The application programs 20 could share one content parsing module 22. The embodiment of the content parsing module 22 could employ the object-oriented program design scheme. The data or event to be received by the dual-screen electronic machine 10 is a known set, and the programmer of object-oriented programming could be based on each element in the known set (i.e. each element is corresponding to a known received data or a known event) for coding the objects used in the element, and, in the method for each object, he could define the instruction result corresponding to the content.

The dual-screen electronic machine 10 according to the present invention could be implemented, for example, as personal digital assistant (PDA), handheld computer, and the like. If the electronic machines implemented with the dual-screen electronic machine 10 are different, the received data and events would be different accordingly. The received data include, for example, text and/or image and/or film and/or digital data, and the like. The events include, for example, the over speed of vehicles, the alarm clock, and the like.

The dual-screen electronic machine with content parsing function according to the present invention could determine and select one from the main display and the sub display based on the received data or event to output and display the data, such that the management for the data and event could have the effect of improved level management, and the user operating the dual-screen electronic machine could more easily handle various statuses, which is the advantage of the present invention.

The present invention have been described in details with the preferred embodiments as above, and these disclosed embodiments are not used to limit the scope of the present invention. The skilled in the art could have various changes and modification without departing from the spirit and scope of the present invention, and these changes and modification are still within the scope of the present invention. The protection scope of the present invention would be defined with the attached claims.

What is claimed is:

1. A dual-screen electronic machine with content parsing function, which comprises:
a processor;
a main display and a sub display, which are connected with the processor;
a content parsing module, which is used to parse the content included in a received data and/or a event, and is based on which application program is the active application program to instruct the active application program for distributing the content to the main display or to the sub display; and,
a memory, which is connected with the processor, and used to store at least one application program, and the application programs are executed by the processor, wherein the active application program would call the content parsing module, and, based on the instruction, display the content on the corresponding main display or sub display.

2. The dual-screen electronic machine according to claim 1, wherein the application programs include a GPS navigation application program and a phone application program.

3. The dual-screen electronic machine according to claim 1, wherein the dual-screen electronic machine is a mobile phone, or a personal digital assistant, or a handheld computer.

4. The dual-screen electronic machine according to claim 1, wherein the received data includes a text, and/or an image, and/or a film, and/or a digital data.

5. A display method applied in a dual-screen electronic machine, in which the dual-screen electronic machine at least comprises: a main display, a sub display, the active application programs, a content parsing module, which comprises the following steps:
the dual-screen electronic machine executes the active application program, and real-time receives a data and/or an event;
the active application program calls the content parsing module, and, based on the instruction of the content parsing module, displays the content on the corresponding main display or sub display, wherein the content parsing module is used to parse the content included in the received data and/or event, and, based on which application program is the active application program, for instructing the active application program to distribute the content to the main display or to the sub display.

6. The display method according to claim 5, wherein the active application program is one of the GPS navigation application and the phone application program.

7. The display method according to claim 5, wherein the dual-screen electronic machine is a mobile phone, a personal digital assistant, and a handheld computer.

8. The display method according to claim 5, wherein the received data includes a text, and/or an image, and/or a film, and/or a digital data.
